(19) United States
(12) Patent Application Publication
(10) Pub. No.: US 2025/0371780 A1
(43) Pub. Date: Dec. 4, 2025

(54) ENHANCEMENT OF EMOTIONAL COMMUNICATION

(71) Applicant: TYXIT SA, Yverdon-les-Bains (CH)

(72) Inventor: Nicolas Abelé, Arlington, MA (US)

(21) Appl. No.: 19/080,414

(22) Filed: Mar. 14, 2025

Related U.S. Application Data
(60) Provisional application No. 63/655,470, filed on Jun. 3, 2024.

(51) Int. Cl. G06T 13/40; G06F 3/0482; G06V 40/16; G10L 25/63

(52) U.S. Cl. CPC G06T 13/40; G06F 3/0482; G06V 40/174; G10L 25/63

(57) ABSTRACT

The invention discloses a method for sharing emotions within communication media using expressive 3D avatars. Users can create or import personalized 3D avatars that represent themselves (optional). The core functionality involves defining “emotion-mojis” by associating predefined animations and/or user-generated animations with specific emotions. These emotion-mojis can also include audio sounds for a richer emotional expression. During communication, users can select an emotion-mojis and initiate the playback of the corresponding animation (visual and/or audio) for their 3D avatar, allowing them to visually and/or audibly express their emotions to other participants. The invention further provides methods for automatic emotion detection through real-time analysis of user input (webcam video and microphone audio) to infer the user's emotional state and automatically play a corresponding emotion-moji. Additionally, users can define their own custom emotion-mojis by recording their body movements and/or facial expressions and associating them with specific emotions. This invention provides a novel approach to emotional expression in communication media by utilizing personalized 3D avatars, predefined and user-generated emotion-mojis, and real-time emotion detection capabilities, fostering a more engaging and nuanced communication experience.

### BACKGROUND

### Technical Field

This invention relates to the field of human-computer interaction (HCl), specifically FOCUSING on user interface (UI) elements for communication applications. More particularly, the invention pertains to methods and systems for enhancing emotional expression within chat, video call, and audio call functionalities.

This invention leverages advancements in several key technical areas such as User Interface (UI) Design which are techniques for creating and integrating novel UI elements within communication applications to facilitate user interaction and convey emotional information. This may involve the use of dynamic avatars, visual effects, or other graphical representations. It also leverages Emotion Detection which are algorithms and frameworks for processing user input (text, audio, video) to identify emotional states. This might involve techniques from computer vision for facial expression recognition, natural language processing for sentiment analysis in text, or audio analysis for vocal cues. It also leverages Data Processing and Analysis which are techniques for processing and analyzing user input data (text, audio, video) in real-time to extract relevant emotional information. This information is then used to inform the dynamic behavior of the UI elements. It also leverages computer Graphics which are techniques for generating and manipulating visual elements such as avatars or other visual representations in real-time. This may involve character animation, color palettes, and other visual effects that dynamically reflect a user's emotional state.

By integrating these technical areas, the invention aims to create a novel communication experience that goes beyond traditional text-based or static emoji expression. It aims to capture and convey emotional nuances through dynamic UI elements, fostering a richer and more engaging communication experience.

### Description of the Related Art

Current communication applications offer various functionalities to facilitate communication but lack a focus on rich emotional expression. Here's an analysis of relevant approaches and their limitations:

Emojis and Animated GIFs: Existing communication applications widely utilize emojis and animated GIFs as a means to convey emotions within text chats. These solutions offer a limited set of pre-defined visual representations of basic emotions. While some platforms offer animated emojis during video calls, these animations are pre-programmed and lack personalization or real-time adaptation to the user's emotional state.

For example, U.S. Pat. No. 11,509,612B2 showcases advancements in core communication functionalities but doesn't address emotional expression directly. It focuses on improving message delivery confirmation mechanisms, similar to read receipts. Other publications, like US2020/0094145A1, explore group communication management features, and publications like US2024/0171623A1 address video call quality enhancements. These advancements, while valuable, don't address the gap in conveying nuanced emotions during communication.

Existing communication solutions have limitations in conveying emotional expression such as limited Expressive Range. For example, Emojis and animated GIFs offer a restricted range of emotions, failing to capture the complexity of human emotions. They also lack Personalization. For example, existing solutions don't personalize the emotional expression to reflect the user's unique emotional state. They also provide inconsistent Experience. For example, emotional expression through emojis or animated GIFs remains static across different communication mediums (chat, video, audio), creating an inconsistent experience.

The limitations of prior art highlight the need for a communication system that allows users to express emotions in a more nuanced, personalized, and consistent manner across different communication channels (chat, video, audio). This system should also create a richer and more engaging communication experience by incorporating dynamic emotional expression.

This invention addresses these limitations by introducing a novel approach to emotional expression within communication applications.

### BRIEF SUMMARY

The present invention relates to a system for enhancing emotional expression within communication applications. The system allows users to create and share personalized three-dimensional (3D) animated avatars that dynamically reflect their emotional state.

This invention addresses the limitations of prior art by providing:
Personalized Avatars: Users can create custom avatars or import existing ones, fostering a more personal communication experience;
Nuanced Emotion Expression: Users can define custom emotions through body language recordings or pre-defined animations, enabling a wider range of emotional expression compared to traditional methods;
Consistent Experience: Emotional expression is conveyed consistently across different communication channels (chat, video call, audio call); and
Engaging Interaction: Dynamic avatar animations create a richer and more engaging communication experience.

This invention provides a novel approach to communication by enabling users to express emotions in a more personalized, nuanced, and consistent manner.

The present invention relates to a computer-implemented method and system for enhancing emotional expression within communication media using 3D avatars. In one embodiment (claim 1), the invention provides a method for sharing emotions during communication. The method allows users to create or import a 3D avatar (optional personalization available), define “emotion-mojis” by associating animations and/or audio sounds with specific emotions (pre-defined or user-generated), and then select an emotion-moji during communication to initiate playback of the corresponding animation (visual and/or audio) for the user's 3D avatar.

Another embodiment details personalization options for the 3D avatar, allowing users to modify physical features and apply visual customizations (skins).

Further embodiments describe functionalities for automatic emotion detection. The system can capture user input through webcam and microphone, analyze it using facial expression recognition and/or voice analysis techniques, infer the user's emotional state, and automatically select and play a corresponding emotion-moji animation and/or audio for the user's avatar.

Embodiment describes how users can define their own custom emotion-mojis by recording their body movements and/or facial expressions and associating them with specific emotions.

Embodiment describes how pre-defined audio sounds can also be associated with specific emotions.

Embodiment describes how selecting an emotion-moji can be done through a user interface element displaying visual representations of the emotion-mojis.

The invention can be implemented as a computer-readable medium storing instructions for execution by a communication application processor (claim 13). The communication application itself can comprise a module configured to perform the aforementioned method. This communication application can support various functionalities like chat, video call, and audio call.

Additional embodiments describe functionalities for designating specific participants in the communication session to view the playback of the user's chosen emotion-moji animation.

Another embodiment describes the ability to create custom emotion-mojis with user-recorded audio.

Other embodiments describe how the communication application can be equipped with modules for capturing user input, analyzing it to infer emotional state, and automatically selecting an emotion-moji based on that analysis.

In an embodiment, the 3D avatar can be used within downloadable software applications or browser-based applications compatible with various platforms.

In an embodiment, in-app shops for purchasing visual customizations (skins) for the 3D avatars can be integrated into the communication application.

Further embodiment describes a user interface element for defining user-generated animations. This element allows users to record their body movements/facial expressions and associate them with specific emotions.

The invention also encompasses a user interface specifically designed for emotional communication applications. This interface comprises a main communication window displaying video feeds or avatars, an avatar panel for the user's customizable 3D avatar, an emotion-moji bar with visual representations of different emotions, and a selection mechanism for users to choose emotion-mojis and initiate playback of corresponding animations and/or audio sounds for their 3D avatar.

This brief description provides a high-level overview of the invention's core functionalities and embodiments. The detailed description section will delve deeper into the specific components, functionalities, and advantages of the invention.

### BRIEF DESCRIPTION OF THE DRAWINGS

The inventive concepts described herein will be better understood thanks to the detailed description which follows and the accompanying drawings, which are given as non-limiting examples of embodiments of the inventive concepts, wherein:

FIG. 1 illustrates the visual interface of a communication software implementing the current invention

FIG. 2 illustrates the emotion-mojis recording and assignment process and assign

FIG. 3 illustrates a method to personalize the creation and recording of the emotion-mojis; and

FIG. 4 illustrates the method to trigger the emotion-mojis during a communication.

FIG. 5 illustrates a method to adapt the avatar emotion based on face or voice analysis.

### DETAILED DESCRIPTION

This detailed description provides a comprehensive overview of the invention, including its components, functionalities, and operational aspects.

The invention is a software-based system designed to enhance emotional expression within communication applications. It operates within a communication application (app) on various platforms (Windows, Mac, IOS, Android, consoles) and can be implemented as downloadable software or a browser-based application.

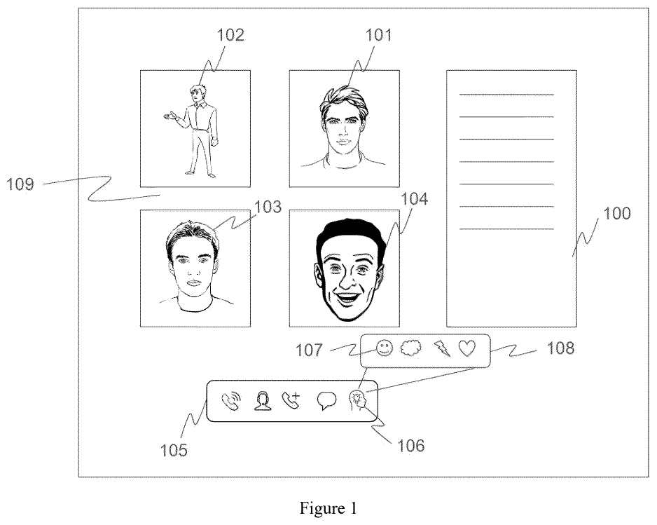

FIG. 1 shows a specific implementation of the invention: Four persons 101, 102, 103 and 104 are communicating over the same communication channel. The communication channel is composed of multiple sections, including a display visualization section 109, a text cat section 100 and a control section 105. FIG. 1 illustrates the case where user 104 selects the emotion-mojis 107 as part of the emotion-mojis menu 106. This selection triggers the change of the avatar 104, using the predefined, eventually customized, avatar animation linked to this specific emotion.

A typical embodiment of the present invention is characterized by a system comprising three core components that work together to facilitate personalized emotional expression through avatars: an avatar creation and customization module, an emotion detection and expression module and emotion sharing during communication module.

The avatar Creation and Customization Module allows users to create their own 3D avatars or import existing ones from external sources.

In one embodiment, this module utilizes a webcam to capture a user's image and generate a base 3D avatar. Users can further personalize their avatars by modifying physical features (optional) and applying visual customizations through “skins.” Skins encompass various customizable appearance elements for the avatar, including but not limited to clothing (shirts, pants, hats, etc.), accessories (jewelry, glasses, etc.) and tattoos.

In an embodiment, skins can be obtained through an in-app shop (purchase or acquisition) or third-party downloads (compatible formats).

The Emotion Detection and Expression Module deals with capturing and expressing user emotions through the avatar. The system offers two primary approaches for defining user emotions:
Pre-defined Emotions: The system provides a library of predefined animations linked to specific emotions (happiness, sadness, anger, etc.). Users can select these predefined emotions for their avatar to display; and
Custom Emotions: Users can create their own custom emotions by recording their own body movements, voice, or a combination of both using a webcam and microphone.

In one aspect of the invention, users can control the intensity of the animation playback to better reflect the degree of an emotion.

In another aspect, the system can automatically suggest emotion-mojis based on the ongoing conversation or user activity (e.g., suggesting a celebratory animation after winning a game). For example, the system can extract information from the video game itself such as winning, losing, need help, team member location, and suggest or automate emotion, animation and/or sound to users to reflect that information. In one embodiment, in a multiplayer game, if the user is placed at a certain location in regard to another team member (i.e. on the right side), the avatar may provide that information to this team member by providing an emotion and/or animation and/or sounds to inform the other members of such location. For example, the avatar may turn his head right if the user has a team member on his right side inside the game.

The system may also integrate a tagging system for user-generated emotion-mojis to allow for easier categorization and search within the user's library.

Each custom emotion can be linked to various expressive elements such as 2D or 3D animations of the avatar performing actions or displaying specific expressions related to the chosen emotion. Audio sounds (e.g., laughter, sighs, gasps) that further enhance the emotional expression. A combination of both visual (animation) and audio (sound) elements for a richer expression. This combination also offers advantageously an alternative form of guidance for users with visual impairments. Sound-based emotion sharing also improves user efficiency by reducing the need for visual confirmation during communication, for example in the case of gaming applications, when teammates want to quickly provide hints or advice to others.

The Emotion Sharing during Communication Module enables users to share their emotions with others during various communication functionalities offered by the app (chat, voice call, video call). The system provides two methods for sharing emotions:
User-Initiated Sharing: Users can trigger the playback of their predefined or custom emotions through a user interface element like an emotion icon bar. Selecting a specific emotion icon within the app initiates the playback of the corresponding animation (visual and/or audio) for the user's avatar, visible to themselves and all other participants in the current communication session (or a selected subset, depending on app functionality); and
Real-Time Emotion Detection: The system can optionally analyze user input (webcam video and microphone audio) in real-time to infer the user's emotional state. This may involve techniques like facial expression recognition, voice analysis, or other relevant methods. The inferred emotional state is then translated into a corresponding animation (visual and/or audio) and displayed through the user's avatar for all participants in the communication session.

The system may also integrate functionalities to improve the user interface, such as:
A dedicated emotion creation studio within the user interface for ease of recording and associating custom emotions;
A “recent emotions” section within the emotion-moji bar for quick access to frequently used emotion-mojis;
Allowing customization of the emotion-moji bar by enabling users to add, remove, or rearrange emotion-mojis based on their preference.

The system may also include features to improve social aspects of emotional communication. This may involve:
Allowing users to share their custom emotion-mojis with other users;
Creating a library of community-generated emotion-mojis that users can download and use; and/or
Implementing features for reacting to other users' emotions with pre-defined animations or text messages.

The system may also include features to facilitate the integration of the emotional communication functionalities with Different Platforms. This may involve:
Creating a software development kit (SDK) that allows developers to integrate the 3D avatar and emotion-moji functionalities into their own communication applications;
Developing browser extensions that enable the use of emotional communication features within existing web-based communication platforms.

In one embodiment, the system Operation follows the following method comprising three steps: “User avatar creation”, “defining user emotion” and “sharing emotions during communication”.

The “User Avatar Creation” step is such that upon first use, users can choose to create a new avatar or import an existing 3D avatar compatible with the system. If creating a new avatar, users can either manually customize the avatar's physical features (optional) or utilize the webcam capture functionality to generate a base 3D avatar resembling the user. Users can then personalize their avatar's appearance by applying various skins (clothing, accessories, tattoos) obtained through the in-app shop or third-party downloads.

The “Defining User Emotions” step is such that users can leverage pre-defined emotions from the system library and assign them to their avatar for quick expression during communication. Alternatively, users can create custom emotions tailored to their unique expressions. This involves recording their body movements using the webcam. Recording their voice using the microphone. Combining these recordings to create a custom emotion animation and sound association.

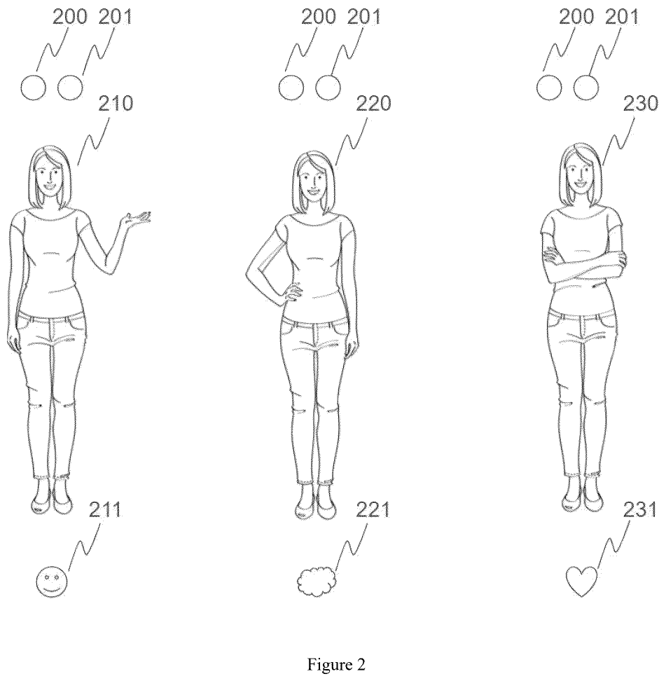

FIG. 2 illustrates an example of the recording of customized emotion using camera device 200 and microphone device 201 to record user body movements 210, 220, 230 and link them to a specific emotion-mojis 211, 221, 231.

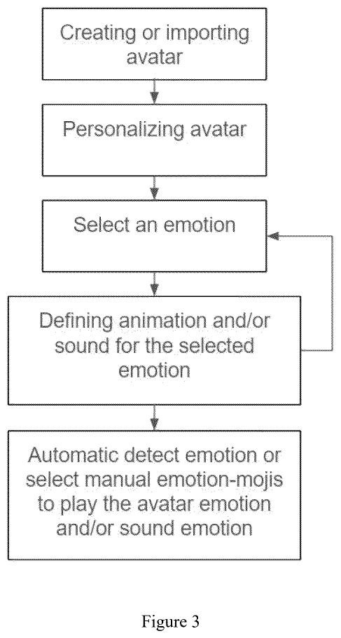

FIG. 3 illustrates a method comprising the step of creating or importing an avatar, personalizing the avatar for example with clothes, haircut, tattoos or other distinctive body elements, selecting an emotion to record, defining an animation or recording a live animation with a camera device, and playing manually or automatically the avatar and/or sound animation to share a given emotion.

In an embodiment, each custom emotion can be linked to specific 2D or 3D animations and/or audio sounds to create a personalized emotional expression for the avatar.

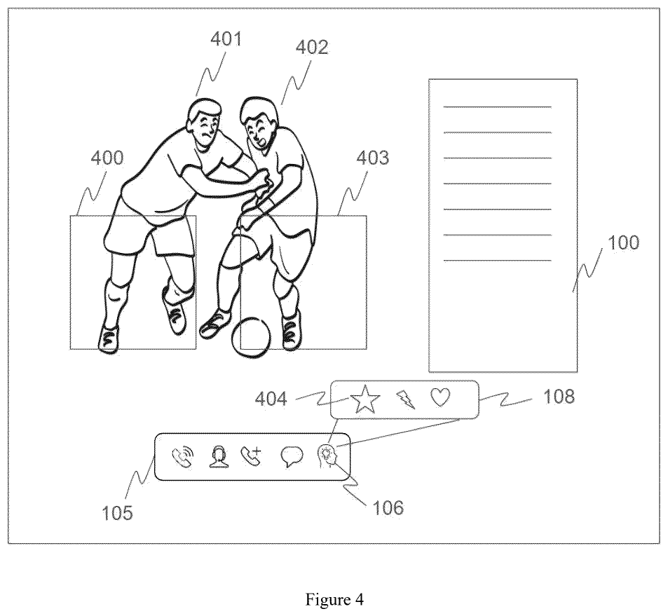

In another embodiment, when clicking on a specific emotion-mojis, avatars can expand beyond their original display box and can eventually start interacting with each other. This may happen for example if two users are hitting the same emotion simultaneously. FIG. 4 illustrates this case, where the avatars 401 and 402 interact with each other beyond their original display box 400 and 403. This may happen when users select the emotion-mojis 404 simultaneously or quasi simultaneously, or for example when the system detects that the users have the same emotion, using for example the camera input and/or their voice analysis as input.

The “Sharing Emotions During Communication” step is such that users can share their emotions with others during any communication session (chat, voice call, video call) offered by the app.

In an embodiment, the user can initiate emotion sharing through a method of selecting a predefined or custom emotion from the user interface (emotion icon bar, menu option, etc.). Selecting the chosen emotion triggers the playback of the corresponding animation (one of visual and/or audio) for the user's avatar, visible to themselves and all participants in the communication session (or a subset depending on app functionality).

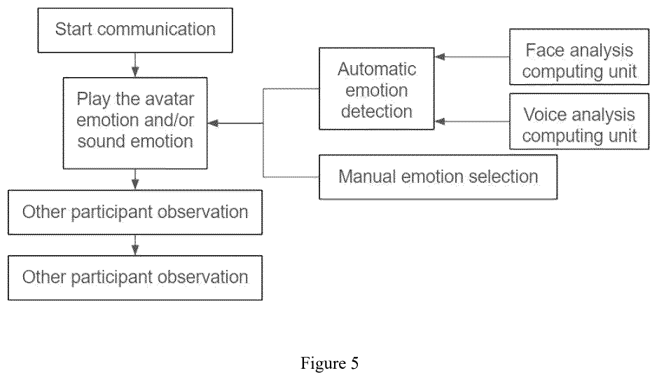

In another embodiment, the user can initiate emotion sharing through a method of enabling real-time emotion detection (optional). If enabled, the system continuously analyzes user input from the webcam (video) and microphone (audio) to infer the user's emotional state. This analysis may involve facial expression recognition algorithms to detect emotions based on facial features. Voice analysis techniques to identify emotional cues in the user's voice. Other relevant methods for emotion detection based on user behavior within the app. FIG. 5 illustrates a method whereby automatic emotion detection is triggered by face analysis computation and/or voice analysis computation. In particular, the computation time and accuracy may be improved by the training of a machine learning algorithm, using a combination of the user input himself when recording his emotion in the first place and linking them to a specific emotion, and machine learning training on an existing dataset of user emotions. To improve the machine learning accuracy, the system may provide a first quick analysis of the users, covering gender, skin color and/or race and select a dataset that has been trained specifically on people of the same type as the user. For example public emotion recognition datasets (e.g., FER-2013) can be used, combined with specific datasets from gamers in the case of gaming applications. Additionally, in the gaming application it will be advantageous to train on gamer's competitors' datasets as they are the most heavy user and most concentrated audience, hence providing accurate emotion as being focused on their gameplay.

The machine learning model shall either be a convolutional neural network (CNN) or a recurrent neural network (RNN). CNNs are usually better at efficient image recognition tasks. They can analyze individual frames from the user's webcam feed quickly, making them suitable for real-time applications like fast-paced gaming. CNNs are adept at identifying spatial patterns in facial expressions, such as the position of eyebrows, mouth, and wrinkles. This is crucial for detecting basic emotions like happiness, anger, or sadness. In addition, CNNs can achieve good performance with smaller training datasets compared to RNNs. This can be advantageous if acquiring a large and diverse dataset specifically for gamers proves challenging. However, CNNs primarily analyze individual frames, potentially missing the temporal context of facial expressions. This can lead to misinterpretations of emotions that unfold over time (e.g., a grimace followed by a smile could be misread as anger). In addition, factors like lighting changes, head orientation, or glasses can affect the accuracy of CNN-based emotion detection. This might require additional calibration for optimal performance within the gaming environment.

On the other hand, Recurrent Neural Networks (RNNs) (Specifically LSTMs) excel at analyzing sequential data like video streams. They can consider the sequence of facial expressions over time, leading to a more nuanced understanding of emotions. This is beneficial for capturing complex emotions that unfold gradually. LSTMs can be combined with other modalities beyond video, such as voice analysis. This could potentially provide a more comprehensive picture of the user's emotional state within the game. However, analyzing sequential data can be computationally expensive for RNNs. This might lead to slower processing times compared to CNNs, potentially impacting real-time performance in fast-paced games. In addition, RNNs often require larger and more diverse training datasets to achieve good accuracy. This could be a challenge if acquiring a substantial amount of labeled data from gamers is difficult.

According to one embodiment, for high performance usage, such as competition, the system will automatically select the trained CNN model to improve speed and efficiency.

According to another embodiment, where emotion details are more important, the system will automatically switch to the trained LSTM machine learning algorithm, to provide more nuanced emotions beyond basic expressions, thanks to the model's ability to analyze temporal context.

According to an embodiment, based on the inferred emotional state, the system automatically displays a corresponding animation (visual and/or audio) through the user's avatar, providing real-time emotional expression during the communication.

As described in FIG. 4, a method is disclosed. The method comprises:
A Start: The communication session begins between participants in a communication media (chat, video call, audio call);
Optionally, a User Creates/Imports Avatar: The user creates a new 3D avatar or imports an existing one to represent themselves (optional);
Optionally, a Personalize Avatar (Optional): The user can personalize the avatar's appearance by modifying physical features and applying visual customizations (skins) (optional);
Defining Emotion-mojis: The user selects pre-defined emotion-mojis from a library. Each emotion-moji is associated with a specific emotion (e.g., happiness, sadness, anger) and has a corresponding animation (visual) and/or audio sound;
Selecting Emotion-Moji: During communication, the user selects a desired emotion-moji from a user interface element (e.g., icon bar);
Playing Animation/Audio: The system initiates playback of the corresponding animation (visual) and/or audio sound linked to the selected emotion-moji for the user's 3D avatar;
Other Participants Observing: Other participants in the communication session observe the user's 3D avatar displaying the selected emotion-moji;
End: The communication session continues, and the user can repeat steps 4-7 to express different emotions.

Alternatively, the “Defining User-Generated Emotion-mojis” step can be a step where the user defines their own emotion-mojis by recording their body movements and/or facial expressions using a webcam and associating the recording with a specific emotion. Similarly, the step of “Playing Animation/Audio” can be such that the system retrieves the user-associated animation (visual) and/or audio sound (if recorded) and initiates playback for the user's 3D avatar;

It is to be noted that this FIG. 4 is a simplified representation and can be further enhanced with additional details like real-time emotion detection and the designation of specific participants to view the emotion-mojis.

The invention can be applied and benefits a number of applications. In gaming applications, it enables to Enhanced Emotional Connection by for example:
Deeper Player Immersion: 3D avatars with a wider range of emotions can create a more immersive and engaging gaming experience. Players can better express their in-game emotions, fostering a deeper connection with their characters and the game world;
Improved Team Communication: Sharing emotions through avatars can be a more intuitive and efficient way to communicate with teammates during online gaming. This can lead to better coordination, strategy, and overall team performance; and
Non-verbal Storytelling: Animations and sounds associated with emotion-mojis can be used to convey complex emotions and add another layer of storytelling within the game. This can enhance the narrative and emotional impact of the gaming experience.

The invention also helps significantly to increase Social Interaction by:
Reducing Text-Based Communication Barriers as emotion-mojis can overcome language barriers and cultural nuances often present in text-based chat. This can facilitate smoother communication and social interaction among players from diverse backgrounds;
Enhancing Player Expression as customizable avatars and user-generated emotion-mojis allow players to express their unique personalities and emotions within the game world. This can foster a stronger sense of community and belonging among players; Creating new Gameplay Mechanics as the invention can introduce novel gameplay mechanics centered around emotional expression. For example, games could involve puzzles or challenges that require players to understand and respond to characters' emotions.

Additional Benefits of the invention includes improving gaming player Experience, especially in the case of multiplayer games by enabling richer emotional expression, the invention can create a more enjoyable and engaging gaming experience for players of all ages and skill levels. It also has potential for Educational Applications for games utilizing emotional communication can be used to teach players about recognizing and understanding emotions in themselves and others. It also opens up monetization opportunities via in-app purchases for avatar customizations and emotion-mojis packs could be a potential revenue stream for game developers.

By incorporating these functionalities, the invention significantly improves the way players interact and express themselves within the gaming world. It can lead to more immersive, engaging, and socially interactive gaming experiences.

The emotional communication invention, with its 3D avatars and emotion-mojis, can also offer several core advantages in competitive gaming environments, particularly those with fast-paced team interactions. In particular it can enhance In-Game Communication by Non-verbal Cues for Rapid Decision-Making. Indeed, in fast-paced games, wasting time typing messages can be detrimental. Emotion-mojis offer a quick and intuitive way for teammates to communicate urgency, excitement, frustration, or strategize visually. A raised first emote could signal readiness, a thumbs up could confirm a plan, and a surprised emoji could warn of an enemy approaching. This rapid communication can lead to quicker and more coordinated team actions. It can also significantly reduce Cognitive Load by Parsing complex information from text chat can be overwhelming in fast-paced games. Emotion-mojis provide a clear and concise way to convey key information, reducing the cognitive load on players and allowing them to focus on gameplay. Finally, it can improve Team Synergy: The ability to visually understand teammates' emotions can foster better team synergy. Seeing a teammate frustrated after a missed shot can encourage words of encouragement or a change in strategy. Conversely, seeing teammate excitement can signal an opportunity for a coordinated attack. This emotional awareness allows for more adaptable and responsive teamwork.

When playing as a team, it can help mitigate Misunderstandings as text-based communication can easily lead to misinterpretations in the heat of the moment. Emotion-mojis can help clarify intent and reduce the risk of teammates taking a frustrated message personally. A playful wink after a friendly fire incident can help maintain team morale. It can also significantly reduce toxicity in gaming as emotion-mojis can provide alternative ways to express frustration without resorting to toxic language. A frustrated emoji can communicate negativity without resorting to hurtful remarks, potentially leading to a more positive and constructive team environment.

In music applications, the invention can enhance music sharing and expression. In particular non-verbal Communication of Emotions as users can leverage emotion-mojis to visually express their feelings (joy, excitement, sadness) while listening to music. This can create a richer and more nuanced way to share music and connect with others based on emotional responses. In addition, customizable 3D avatars can act as a visual representation of the user's musical taste. Avatars can be dressed in clothing or accessories associated with specific genres or artists, allowing for a more personalized music experience. Finally, emotions displayed by user avatars can potentially be synchronized with the music. Avatars could dance, move, or change expressions based on the tempo, rhythm, and mood of the music, creating a more visually engaging experience.

In Music applications, the invention can also improve Social Interaction. An embodiment includes a music discovery feature as users could join communities based on shared emotional responses to music. Emotion-mojis can be a quick and easy way to express how a song makes you feel, fostering discussions and connections between like-minded music lovers. Another embodiment includes a feature whereby users can browse through playlists or artist profiles and see how other users' avatars react to different songs. Another embodiment includes a feature whereby users discover new music based on the emotional responses of others. Emotion-mojis can also be used during collaborative music creation sessions, allowing musicians to communicate ideas and feelings nonverbally.

Benefits of this invention in this application, includes:
Music Education & Appreciation: Apps utilizing emotional communication can be developed to help users identify and understand emotions evoked by different music genres or instruments;
Accessibility for People with Disabilities: Emotion-mojis can provide an alternative way for people with difficulty expressing themselves verbally to share their musical preferences and connect with others; and
Artist Engagement & Marketing: Artists could use emotion-mojis to interact with fans and gauge their emotional responses to new releases. This data can be valuable for understanding audience preferences and marketing strategies.

In the metaverse application, the invention can provide Deeper Social Connection and Expression. In particular in non-verbal Communication as Emotion-mojis provide a natural way to express emotions in the metaverse, overcoming language barriers and cultural nuances. This fosters more intuitive and nuanced communication, leading to stronger social connections and a richer sense of presence within the virtual world. The invention also provides enhanced Body Language as 3D avatars have a wider range of emotions that can convey subtle emotional cues through body language and facial expressions. This allows users to express complex emotions without relying solely on text or voice chat. The invention also helps in building trust and rapport as the ability to express and understand emotions visually can lead to a more human-like interaction within the metaverse. This can help users build trust and rapport with each other, fostering a more positive and engaging social environment.

For this application, in one embodiment users can design avatars that reflect their personalities and emotions. This allows for self-expression and creates a sense of ownership within the metaverse. In another embodiment, the metaverse could detect and adapt to the user's emotional state through facial recognition or biofeedback sensors. This could lead to personalized experiences such as recommending virtual spaces or activities that match the user's mood. In another embodiment, the invention can enhance storytelling and roleplay within the metaverse. Avatars with rich emotional expression can be used to create more immersive and impactful virtual experiences.

Those embodiments provide a number of advantages including for education purposes as their implementation in the metaverse can be used to teach people about emotional intelligence and communication skills through interactive experiences that incorporate emotional expression. It can also provide mental Health Support as the invention could be used to create safe spaces within the metaverse where users can express their emotions and connect with others for support. It can also provide an enhanced customer service as businesses operating in the metaverse can utilize emotional communication to provide more personalized and empathetic customer service experiences.

This invention offers several advantages over existing communication applications such as highly personalized: Users can create avatars that resemble them or reflect their unique style, fostering a more personal communication experience, nuanced emotional Expression: Custom emotions and sounds allow for a wider range of emotions compared to emojis or GIFs, enabling richer communication, consistent experience: Emotions are conveyed consistently across chat, video call, and audio call functionalities, providing a seamless experience. Engaging Interaction: Sharing emotions through dynamic avatars creates a more engaging and interactive communication experience.

What is claimed is:

1. A method for sharing emotions in a communication media, comprising:
creating or importing a 3D avatar;
optionally personalizing the 3D avatar to represent the user's appearance;
defining emotion-mojis by associating predefined or user-generated animations and/or audio sounds with specific emotions;
during communication within the communication media, selecting an emotion-moji and initiating the playback of the corresponding animation (visual and/or audio) for the user's 3D avatar.

2. The method according to claim 1, wherein personalizing the 3D avatar comprises modifying physical features and applying visual customizations (skins) such as clothing, accessories, and tattoos.

3. The method according to claim 1, further comprising:
capturing user input through a webcam (video) and microphone (audio) in real-time;
analyzing the captured user input to infer the user's emotional state;
automatically selecting an emotion-moji based on the inferred emotional state and initiating the playback of the corresponding animation (visual and/or audio) for the user's 3D avatar.

4. The method according to claim 1, wherein analyzing the captured user input utilizes facial expression recognition algorithms and/or voice analysis techniques.

5. The method according to claim 1, further comprising:
defining a user-generated animation by recording the user's body movements and/or facial expressions using a webcam;
associating the user-generated animation with a specific emotion.

6. The method according to claim 1, further comprising associating pre-defined audio sounds with specific emotions.

7. The method according to claim 1, wherein selecting an emotion-moji comprises selecting from a user interface element and displaying visual representations of the emotion-mojis.

8. The method according to claim 1, wherein selecting an emotion-moji further comprises designating a subset of participants in the communication session to view the playback of the corresponding animation for the user's 3D avatar.

9. The method according to claim 1, further comprising associating a user-recorded audio sound with the user-generated animation.

10. The method according to claim 1, wherein the 3D avatar is operable within a downloadable software application or a browser-based application compatible with various platforms.

11. The method according to claim 1, wherein the communication media comprises chat, video call, and audio call functionalities.

12. The method according to claim 1, further comprising providing a user interface element to allow the user to designate a subset of participants in the communication session to view the playback of the animation for the user's 3D avatar.

13. A computer-readable medium storing instructions which, when executed by a processor of a communication application, perform the method according to claim 1.

14. The computer-readable medium according to claim 13, further comprising a module for capturing user input through a webcam and microphone.

15. The computer-readable medium according to claim 13, further comprising a module for analyzing the captured user input to infer the user's emotional state.

16. The computer-readable medium according to claim 13, further comprising a module for automatically selecting an emotion-moji based on the inferred emotional state.

17. The computer-readable medium according to claim 16, whereby the automatic selection of the emotion is generated by a training machine learning algorithm.

18. The computer-readable medium according to claim 13, further comprising an in-app shop where users can purchase or acquire visual customizations (skins) for their 3D avatars.

19. The computer-readable medium according to claim 13, further comprising a user interface element for defining user-generated animations and wherein the user interface element allows the user to record their body movements and/or facial expressions using a webcam and associate the recording with a specific emotion.

20. A user interface for an emotional communication application, comprising:
a main communication window displaying video feeds or avatars of participants in a communication session;
an avatar panel displaying a user's 3D avatar, wherein the 3D avatar is customizable with visual elements;
an emotion-mojis bar displaying a collection of emotion-mojis, each emotion-moji represented by an icon visually depicting an associated emotion; and
a selection mechanism configured to allow the user to select an emotion-moji from the emotion-mojis bar, wherein selecting an emotion-moji initiates playback of a corresponding animation and/or audio sound for the user's 3D avatar within the avatar panel.
